(19) United States
(12) Patent Application Publication
(10) Pub. No.: US 2026/0141278 A1
(43) Pub. Date: May 21, 2026

(54) SIMULATING GENERAL DYNAMIC QUANTUM CIRCUITS

(71) Applicant: International Business Machines Corporation, Armonk, NY (US)

(72) Inventors: Derek Wang, New York, NY (US); Alireza Seif Tabrizi, Adelphi, MD (US); Ali Javadiabhari, Sleepy Hollow, NY (US)

(21) Appl. No.: 18/952,374

(22) Filed: Nov. 19, 2024

(51) Int. Cl. G06N 10/20

(52) U.S. Cl. CPC G06N 10/20

(57) ABSTRACT

One or more systems, devices, computer program products and/or computer-implemented methods of use provided herein relate to efficient and parallelizable simulations of dynamic quantum circuits. For example, according to an embodiment, a system is provided. The system can comprise a memory that can store computer executable components. The system can further comprise a processor that can execute the computer executable components stored in the memory, where the computer executable components can comprise a storage component that can store a set of wave functions corresponding to a quantum system. The computer executable components can further comprise a simulation component that can execute, based on one or more wave functions of the set of wave functions, one or more simulation shots on a quantum computer.

### BACKGROUND

The subject disclosure relates to dynamic quantum circuits and, more specifically, to efficient and parallelizable simulations of dynamic quantum circuits.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable efficient and parallelizable simulations of dynamic quantum circuits are discussed.

According to an embodiment, a system is provided. The system can comprise a memory that can store computer executable components. The system can further comprise a processor that can execute the computer executable components stored in the memory, where the computer executable components can comprise a storage component that can store a set of wave functions corresponding to a quantum system. The computer executable components can further comprise a simulation component that can execute, based on one or more wave functions of the set of wave functions, one or more simulation shots on a quantum computer.

According to another embodiment, a system is provided. The system can comprise a memory that can store computer executable components. The system can further comprise a processor that can execute the computer executable components stored in the memory, where the computer executable components can comprise a storage component that can store respective wave functions and respective measurement probabilities for respective trajectories of classical measurements corresponding to a dynamic quantum circuit. The system can further comprise a simulation component that can compute, based on the respective wave functions and the respective measurement probabilities, a set of observables.

According to yet another embodiment, a system is provided. The system can comprise a memory that can store computer executable components. The system can further comprise a processor that can execute the computer executable components stored in the memory, where the computer executable components can comprise a compilation component that can compile a dynamic quantum circuit into a unitary quantum circuit comprising ancilla qubits. The system can further comprise a simulation component that can simulate the dynamic quantum circuit by executing the unitary quantum circuit.

According to various embodiments, the above-described systems can be implemented as computer-implemented methods or as a computer program products.

### BRIEF DESCRIPTION OF THE DRAWINGS

One or more embodiments are described below in the Detailed Description section with reference to the following drawings:

FIG. 1 illustrates a block diagram of an example, non-limiting system that can efficiently simulate general dynamic quantum circuits, in accordance with one or more embodiments described herein.

FIG. 2 illustrates another block diagram of an example, non-limiting system that can efficiently simulate general dynamic quantum circuits, in accordance with one or more embodiments described herein.

FIG. 3 illustrates a flow diagram of an example, non-limiting method that can efficiently and parallelly simulate general dynamic quantum circuits, in accordance with one or more embodiments described herein.

FIG. 4 illustrates diagrams of an example, non-limiting dynamic quantum circuit and example, non-limiting simulation shots to describe a greedy approach and a tabular approach of simulating a dynamic quantum circuit, in accordance with one or more embodiments described herein.

FIG. 5 illustrates a diagram of an example, non-limiting quantum circuit to describe a deferred measurement approach of simulating a dynamic quantum circuit, in accordance with one or more embodiments described herein.

FIG. 6 illustrates a flow diagram of an example, non-limiting method to describe a deferred measurement approach of simulating a dynamic quantum circuit, in accordance with one or more embodiments described herein.

FIG. 7 illustrates a flow diagram of an example, non-limiting method to show the computation of parity in the deferred measurement approach of simulating a dynamic quantum circuit, in accordance with one or more embodiments described herein.

FIG. 8 illustrates flow diagrams of example, non-limiting methods that can efficiently simulate general dynamic quantum circuits, in accordance with one or more embodiments described herein.

FIG. 9 illustrates another flow diagram of an example, non-limiting method that can efficiently simulate general dynamic quantum circuits, in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute the computer executable components stored in the memory, where the computer executable components can comprise a storage component that can store a set of wave functions corresponding to a quantum system. The computer executable components can further comprise a simulation component that can execute, based on one or more wave functions of the set of wave functions, one or more simulation shots on a quantum computer.

Such embodiments of the system can provide a number of advantages, including reducing the number of computations and reducing the computational time involved in simulating dynamic quantum circuits.

In one or more embodiments of the aforementioned system, the set of wave functions can represent a state of the quantum system resulting from application of a conditional unitary operation to qubits comprised in the quantum system, and the system can further comprise an operation execution component that can apply the conditional unitary operation to the qubits, where the conditional unitary operation can be based on classical bits that can result from measurement of one or more qubits comprised in the quantum system, and where the conditional unitary operation can be applied as a simulation shot.

Such embodiments of the system can provide the advantage of efficiently simulating a variety of dynamic quantum circuits comprising different quantum operations.

In one or more embodiments of the aforementioned system, a measurement component can measure the one or more qubits subsequent to application of a set of unitary operations to the one or more qubits.

Such embodiments of the system can provide the advantage of efficiently simulating a variety of dynamic quantum circuits comprising different quantum operations.

In one or more embodiments of the aforementioned system, the operation execution component can further apply the set of unitary operations to the one or more qubits.

Such embodiments of the system can provide the advantage of efficiently simulating a variety of dynamic quantum circuits comprising different quantum operations.

In one or more embodiments of the aforementioned system, the set of wave functions can represent a state of the quantum system resulting from a parallel application of multiple respective conditional unitary operations to qubits comprised in the quantum system, and the simulation component can execute, based on the state of the quantum system, a plurality of simulation shots in parallel.

Such embodiments of the system can provide the advantage of simulating dynamic quantum circuits efficiently and parallelly.

In one or more embodiments of the aforementioned system, the simulation shot and the one or more simulation shots can be executed to simulate a dynamic quantum circuit.

Such embodiments of the system can provide the advantage of efficiently simulating a variety of dynamic quantum circuits comprising different quantum operations.

In one or more embodiments of the aforementioned system, employing stored wave functions to execute the one or more simulation shots can reduce a computational time involved in simulating the dynamic quantum circuit.

Such embodiments of the system can provide a number of advantages, including developing applications/algorithms with a variety of dynamic quantum circuits, efficiently simulating quantum error correcting codes and implementing fault-tolerant algorithms.

According to another embodiment, a system is provided. The system can comprise a memory that can store computer executable components. The system can further comprise a processor that can execute the computer executable components stored in the memory, where the computer executable components can comprise a storage component that can store respective wave functions and respective measurement probabilities for respective trajectories of classical measurements corresponding to a dynamic quantum circuit. The system can further comprise a simulation component that can compute, based on the respective wave functions and the respective measurement probabilities, a set of observables.

Such embodiments of the system can provide a number of advantages, including reducing the number of computations involved in simulating dynamic quantum circuits, reducing the computational time involved in simulating dynamic quantum circuits and generating exact expectation values for observables.

In one or more embodiments of the aforementioned system, a computation component can compute the respective wave functions and the respective measurement probabilities for the respective trajectories of classical measurements, where the respective wave functions and the respective measurement probabilities can be computed parallelly.

Such embodiments of the system can provide the advantage of simulating dynamic quantum circuits efficiently and parallelly.

In one or more embodiments of the aforementioned system, the set of observables can have a defined time complexity, and the set of observables can be computed to simulate the dynamic quantum circuit.

Such embodiments of the system can provide the advantage of evaluating and optimizing the computational efficiencies of quantum algorithms.

According to yet another embodiment, a system is provided. The system can comprise a memory that can store computer executable components. The system can further comprise a processor that can execute the computer executable components stored in the memory, where the computer executable components can comprise a compilation component that can compile a dynamic quantum circuit into a unitary quantum circuit comprising ancilla qubits. The system can further comprise a simulation component that can simulate the dynamic quantum circuit by executing the unitary quantum circuit.

Such embodiments of the system can provide a number of advantages, including compiling the dynamic quantum circuit with a reduced number of ancilla qubits, reducing the computational time involved in simulating dynamic quantum circuits and simulating the dynamic quantum circuit with a single wave function.

In one or more embodiments of the aforementioned system, simulation of the dynamic quantum circuit can generate a sparse matrix, and the system can further comprise a computation component that can compute, based on the sparse matrix, a set of observables with a defined time complexity.

Such embodiments of the system can provide a number of advantages, including generating exact expectation values of observables and ensuring that the complexity of the quantum system does not grow similar to that of dense circuits of the same size as the dynamic quantum circuit.

In one or more embodiments of the aforementioned system, the dynamic quantum circuit can be simulated with a defined number of elements.

Such embodiments of the system can provide the advantage of reducing the computational complexity involved in simulating the dynamic quantum circuit.

In one or more embodiments of the aforementioned system, compiling the dynamic quantum circuit into the unitary quantum circuit can expand a Hilbert space associated with the dynamic quantum circuit.

Such embodiments of the system can provide a number of advantages, including enhancing the stability of the quantum system and enabling powerful and fault-tolerant quantum computations.

In one or more embodiments of the aforementioned system, the unitary quantum circuit can be associated with a single wave function.

Such embodiments of the system can provide the advantage of reducing the number of computations involved in simulating dynamic quantum circuits.

An embodiment in which the storage component can store a set of wave functions corresponding to a quantum system, and the simulation component can execute, based on the set of wave functions, a plurality of simulation shots in parallel has the advantages of simulating the dynamic quantum circuit with a reduced number of computations and reduced computing time.

An embodiment in which the computation component can compute the respective wave functions and the respective measurement probabilities for the respective trajectories of classical measurements parallelly, the storage component can store the respective wave functions and the respective measurement probabilities, and the simulation component can compute, based on the respective wave functions and the respective measurement probabilities, a set of observables has the advantages of simulating the dynamic quantum circuit with a reduced number of computations and reduced computing time and generating exact expectation values for the observables.

The various embodiments disclosed herein can be employed as a software to simulate dynamic quantum circuits for applications such as dynamical decoupling for dynamic quantum circuits, discovering new dynamic quantum circuits with machine learning, compilation of classical logic in dynamic quantum circuits and mapping qubits in dynamic quantum circuits that can be part of a high-value portfolio of dynamic circuits software. Such software can also be employed to onboard potential new device users to employ devices by first providing them with the tools to simulate dynamic circuits.

According to various embodiments, the above-described systems can be implemented as computer-implemented methods or as a computer program products.

### Definitions

Dynamic quantum circuits: A dynamic quantum circuit is a quantum circuit comprising mid-circuit measurements and feed-forward operations. Dynamic quantum circuits are also known as adaptive circuits.

Principle of deferred measurement: This principle states that the outcome of a quantum measurement can be delayed without altering the final results. In one or more embodiments of the present disclosure, the principle of deferred measurement can be employed to convert a dynamic quantum circuit based on classical logic and classical bits into a static quantum circuit comprising only qubits. In doing so, the Hilbert space can expand, but the new (static) quantum circuit can be more efficiently simulated by employing parallelization techniques. Throughout the present disclosure, this approach has been referred to as the deferred measurement approach of simulating a dynamic quantum circuit.

A dynamic quantum circuit is a type of quantum circuit that is adaptive in nature because executing a dynamic quantum circuit involves taking a measurement after specific quantum operations comprised in the dynamic quantum circuit, wherein a measurement taken after a quantum operation collapses the qubits being measured into classical outcomes. The classical outcomes resulting from the measurement can then be employed to influence a subsequent quantum operation. For example, based on the classical outcomes, the dynamic quantum circuit can determine the quantum gates or quantum operations to be applied to one or more qubits as part of the subsequent quantum operation. The intermediate measurements thus performed are known as mid-circuit measurements, and the quantum operations conditionally applied to qubits based on the mid-circuit measurements are known as feed-forward operations or conditional operations. Thus, executing a dynamic quantum circuit involves quantum operations that are conditional upon classical information.

From generating long-range entanglements more efficiently, to efficiently executing quantum algorithms and core algorithmic primitives like the quantum Fourier transform, to comprising the foundation of active quantum error correction, dynamic quantum circuits are a fundamental part of utility-scale quantum computations. Dynamic quantum circuits are quantum circuits where classical information from mid-circuit measurements is logically processed and fed forward to shape the dynamic quantum circuit in real time within a given shot (i.e., execution) of the dynamic quantum circuit. The kinds of logical processes available can broadly comprise repeat-until-success processes such as those involved in active quantum error correction, quantum state preparation or logical branching to implement state and gate teleportation.

Thus, dynamic quantum circuits are a very useful class of quantum circuits that can have various applications. Dynamic quantum circuits can be simulated to boost quantum computations, perform compilations and generally explore and learn new concepts within quantum computing. Simulating dynamic quantum circuits is also central to quantum processing unit (QPU) operations and in enabling discoveries of quantum error-correcting codes, artificial intelligence (AI) compilation of quantum circuits and measurement-based error mitigation. Existing approaches to simulate dynamic quantum circuits are often lacking in one or more criteria. For example, although existing simulators of dynamic quantum circuits can allow mixed-state simulations that can handle the statistical mixtures generated through mid-circuit measurements and feed-forward operations, such simulators can only simulate dynamic quantum circuits via a series of sequential shots (i.e., shot-by-shot) which can be space-inefficient and time-inefficient. Similarly, other existing techniques can only be employed for very specific operations such as Clifford gates and measurements. However, dynamic quantum circuits can typically comprise a variety of operations. Some other existing techniques can generally be employed to simulate dynamic quantum circuits; however, such techniques are also limited to certain classes of quantum circuits that only generate low entanglement. Thus, efficient methods to simulate dynamic quantum circuits, that are more space-efficient and time-efficient as compared to existing techniques, and that can be generally applied to a variety of dynamic quantum circuits (i.e., general dynamic quantum circuits) are desirable.

Various embodiments of the present disclosure can be implemented to produce a solution to these problems. Embodiments described herein include systems, computer-implemented methods, and computer program products that can enable efficient and parallelizable simulations of dynamic quantum circuits. Accordingly, in various embodiments, different methods for simulating adaptive or dynamic quantum circuits with improved efficiency and parallelizability are provided. In a first method known as the greedy approach, a dynamic quantum circuit can be simulated by executing simulation shots consecutively (i.e., shot-by-shot). For example, in one or more embodiments, unitary operations can be applied to a first set of qubits comprised in a dynamic quantum circuit, and the qubits can be measured to obtain classical bits. Thereafter, conditional unitary operations can be applied to a second set of qubits based on the classical bits. The wave functions resulting from application of each conditional unitary operation can be stored after execution of the conditional unitary operation, and the stored wave functions can be re-employed in subsequent simulation shots that follow the same trajectory of classical measurements, thereby reducing a computational time involved in generating the wave functions, at the cost of additional memory consumption. The greedy approach can be parallelized by running multiple shots in parallel, combining the newly generated wave functions in a memory, and employing the memory of stored wave functions in subsequent cycles of parallel simulation shots.

In one or more embodiments, a second method known as the tabular approach is provided to simulate dynamic quantum circuits. In the tabular approach, the wave function and measurement probability for each trajectory of classical measurements (i.e., mid-circuit measurements) can be pre-computed and stored in a memory to simulate a dynamic quantum circuit. In contrast to the greedy approach, no intermediary wavefunctions need to be stored in the tabular approach. In one or more embodiments, the stored wave functions and measurement probabilities can be employed to compute expectation values of observables with a time complexity of 2^{2*num_qubits+num_measurement}, where the factor of 2^{num_measurement} can be trivially parallelized.

In one or more embodiments, a third method known as the deferred measurement approach is provided to simulate dynamic quantum circuits. In the deferred measurement approach, mid-circuit measurements comprised in a dynamic quantum circuit can be stored into ancilla qubits by employing methods of classical logical synthesis. Thereafter, the operation of the entire dynamic quantum circuit can be computed as a function with 2^{num_qubits+num_ancilla} elements. Leveraging the sparsity of a matrix resulting from the computation, expectation values of observables can be computed with a time complexity of 2^{2*num_qubits+num_ancilla}, where the factor of 2^{num_ancilla} can be trivially parallelized or with a time complexity identical to that of the tabular approach. An advantage herein is that the deferred measurement approach can be straightforwardly implemented within a software stack as a transpilation pass converting dynamic operations involving classical logic into a unitary quantum circuit with a larger, but sparsely occupied, Hilbert space as compared to that corresponding to the dynamic quantum circuit.

Embodiments of the present disclosure can integrate modularly with existing quantum computing techniques in the art, and unlock value in both the near-term and the long-term towards fault-tolerant devices. For example, embodiments of the present disclosure can be employed to develop applications/algorithms with dynamic quantum circuits in the near-term, and to simulate quantum error correcting codes and fault-tolerant algorithms in the long-term. Additionally, embodiments of the present disclosure can be applied to various quantum computing architectures, including, but not limited to supercomputing qubit architectures.

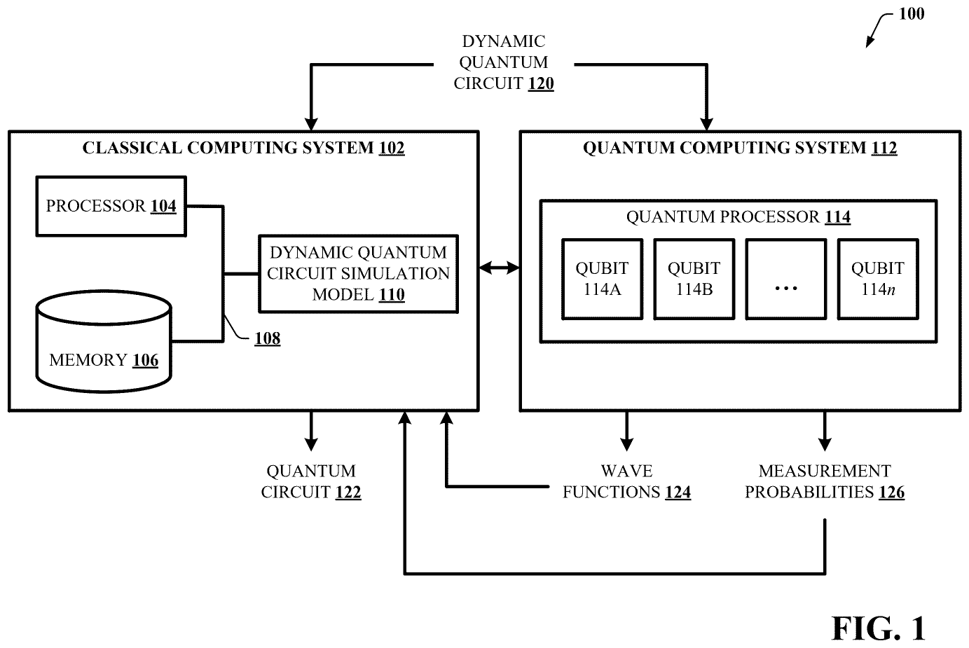

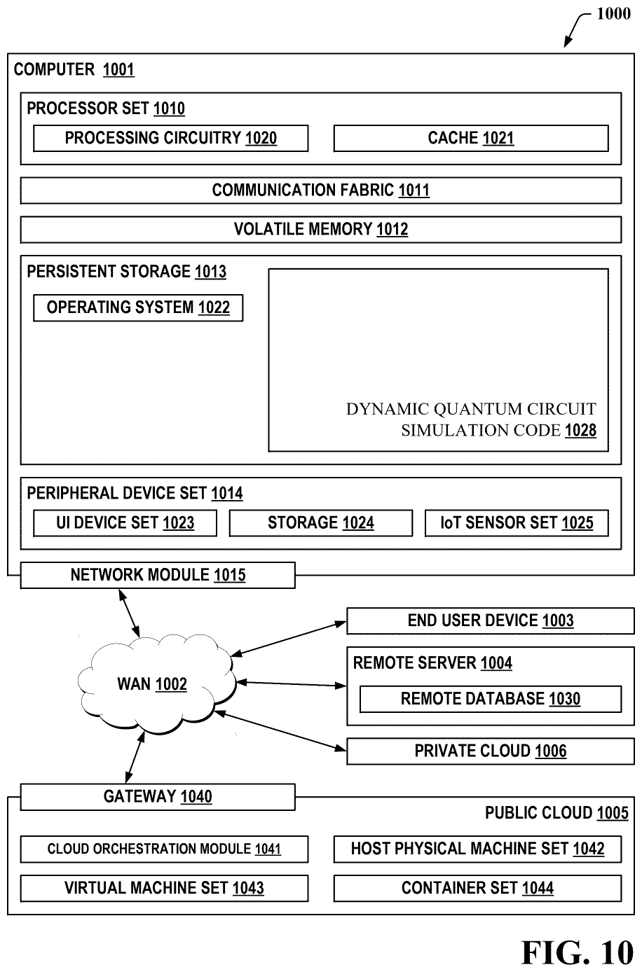

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, non-limiting system 100 can be associated with, such as accessible via, a computing environment 1000 described below with reference to FIG. 10, such that aspects of processing can be distributed between non-limiting system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can efficiently simulate general dynamic quantum circuits, in accordance with one or more embodiments described herein.

Non-limiting system 100 and/or the components of non-limiting system 100 can be employed to use hardware and/or software to solve problems that are highly technical in nature (e.g., related to quantum computing, dynamic quantum circuits, simulations of dynamic quantum circuits, etc.), that are not abstract and that cannot be performed as a set of mental acts by a human. Further, some of the processes performed may be performed by specialized computers for carrying out defined tasks related to the efficient and parallelizable simulations of dynamic quantum circuits. Non-limiting system 100 and/or components of non-limiting system 100 can be employed to solve new problems that arise through advancements in technologies mentioned above and/or the like. Non-limiting system 100 can provide technical improvements to quantum systems by increasing the efficiency and parallelizability of simulating general dynamic quantum circuits, reducing the number of computations involved in simulating dynamic quantum circuits, reducing the computational time involved in simulating dynamic quantum circuits, and reducing the computational cost of simulating dynamic quantum circuits.

Existing simulation methods are not efficient, parallelizable or applicable to general dynamic quantum circuits. For example, existing simulators either generate a full density matrix or propagate a state vector shot-by-shot. The former approach can be time-inefficient because the matrix operation for computing observables may not be accelerated with sparse techniques or parallelized. The latter approach can also be time-inefficient because previously visited state functions are recomputed shot-by-shot. In an existing technique, non-Clifford gates cannot be employed, thereby preventing the technique from being a general dynamic quantum circuit simulator. Yet another existing technique is limited by its ability to store quantum states with large amounts of entanglement, thereby preventing the technique from being general dynamic quantum circuit simulators. On the contrary, dynamic quantum circuit simulation model 110 described in various embodiments herein can be a more lightweight and general simulator of dynamic quantum circuits of various types (i.e., general dynamic quantum circuits) as compared to existing simulation methods.

As illustrated in FIG. 1, non-limiting system 100 can comprise classical computing system 102 and quantum computing system 112. Classical computing system 102 can be coupled (operatively, communicatively, electrically, and/or like function) to quantum computing system 112. Classical computing system 102 can comprise one or more components, such as a memory 106, processor 104, bus 108, and/or dynamic quantum circuit simulation model 110. Quantum computing system 112 can comprise at least one quantum processor, such as quantum processor 114. Quantum processor 114 can comprise a quantum logic circuit comprising one or more qubits, such as qubit 114A, qubit 114B, . . . , qubit 114n, etc., where n represents a positive integer. Quantum processor 114 can be any suitable processor. Quantum processor 114 can generate one or more instructions for controlling the quantum logic circuit. In an embodiment, quantum computing system 112 can be a classical simulator of a quantum computer. In an embodiment, dynamic quantum circuit simulation model 110 can be comprised at least partially by quantum computing system 112.

Discussion turns briefly to processor 104, memory 106 and bus 108 of classical computing system 102. For example, in one or more embodiments, classical computing system 102 can comprise processor 104 (e.g., computer processing unit, microprocessor, classical processor, and/or like processor). In one or more embodiments, a component associated with classical computing system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, classical computing system 102 can comprise a computer-readable memory (e.g., memory 106) that can be operably connected to processor 104. Memory 106 can store computer-executable instructions that, upon execution by processor 104, can cause processor 104 and/or one or more other components of classical computing system 102 (e.g., computation component 202, storage component 204, simulation component 206, measurement component 208, compilation component 210 and/or operation execution component 212) to perform one or more actions. In one or more embodiments, memory 106 can store computer-executable components (e.g., computation component 202, storage component 204, simulation component 206, measurement component 208, compilation component 210 and/or operation execution component 212).

Classical computing system 102 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

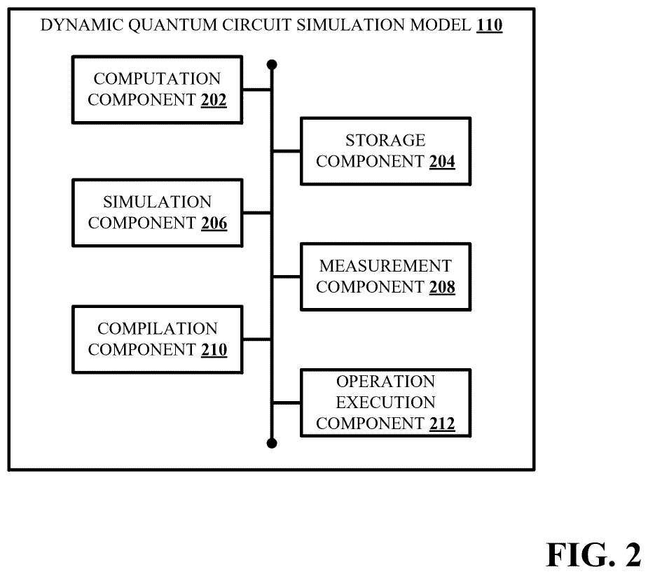

In various embodiments, dynamic quantum circuit simulation model 110 can comprise computation component 202, storage component 204, simulation component 206, measurement component 208, compilation component 210 and/or operation execution component 212, as illustrated in FIG. 2. In various embodiments, dynamic quantum circuit simulation model 110 can perform efficient and parallelizable simulation of dynamic quantum circuit 120 via a greedy approach, a tabular approach or a deferred measurement approach. The three methods (i.e., the greedy approach, the tabular approach and the deferred measurement approach) can be complementary to each other, and each method can be parallelized to enable computations of various parameters of dynamic quantum circuit 120. The following discussion describes each of the three methods in greater detail.

### Greedy Approach:

In one or more embodiments, dynamic quantum circuit simulation model 110 can save wave functions previously visited/generated during simulation of quantum operations comprised in dynamic quantum circuit 120. For example, in one or more embodiments, quantum computing system 112 can be employed to simulate dynamic quantum circuit 120. In one or more embodiments, during simulation of dynamic quantum circuit 120, operation execution component 212 can apply a set of unitary operations to one or more qubits comprised in the quantum system of dynamic quantum circuit 120. Thereafter, in one or more embodiments, measurement component 208 can measure the one or more qubits (e.g., via a mid-circuit measurement operation). Measuring the one or more qubits can collapse the qubits from a quantum state to a classical state represented by classical bits. In one or more embodiments, operation execution component 212 can apply, based on the classical bits, a conditional unitary operation to qubits, wherein the qubits can comprise the one or more qubits to which the set of unitary operations was applied and/or any combination of qubits of dynamic quantum circuit 120. Additionally, the conditional unitary operation can be applied as a simulation shot to simulate dynamic quantum circuit 120. Application of the conditional unitary operation to the qubits can generate a set of wave functions (i.e., wave functions 124) that can represent a quantum state of the quantum system of dynamic quantum circuit 120 resulting from application of the conditional unitary operation. Stated differently, application of the conditional unitary operation to the qubits can update the wave functions of the qubits, and the updated wave functions (i.e., wave functions 124) can describe the state of dynamic quantum circuit 120 as a result of the conditional unitary operation.

In one or more embodiments, storage component 204 can store wave functions 124 corresponding to the quantum system of dynamic quantum circuit 120 in a shared memory (e.g., memory 106 or another memory) accessible to one or more components comprised in dynamic quantum circuit simulation model 110. Storage component 204 can further store measurement probabilities 126 corresponding to wave functions 124 in the shared memory. A measurement probability can refer to the likelihood of obtaining a specific outcome upon measuring a qubit, and the measurement probability can be based on the quantum state of a qubit, wherein the quantum state can be represented by a wave function. Thus, respective measurement probabilities comprised in measurement probabilities 126 can correspond to respective wave functions comprised in wave functions 124, and measurement probabilities 126 can influence the outcomes of subsequent conditional unitary operations in a dynamic quantum circuit 120. Further, in one or more embodiments, simulation component 206 can execute, based on one or more wave functions of wave functions 124 stored in the memory, one or more simulation shots on a quantum computer (e.g., quantum computing system 112) to further simulate dynamic quantum circuit 120, wherein respective simulation shots can correspond to respective conditional unitary operations. That is, simulation component 206 can employ stored wave functions to execute feed-forward operations that can be applied to qubits comprised in dynamic quantum circuit 120.

In some existing approaches of simulation dynamic quantum circuits (i.e., without employing embodiments of the present disclosure), each simulation shot comprising the application of a conditional unitary operation to a set of qubits in the dynamic quantum circuit is executed. Recall that conditional operations in dynamic quantum circuits depend on the results of preceding mid-circuit measurements. As a result, the different simulation shots can be visualized as a tree or a tree-like structure representing potential paths along which the simulation can progress, depending on the results of different mid-circuit measurements. Existing simulation software do not have memory of which branches of the tree have been visited during the simulation because the results of mid-circuit measurements are discarded and the process continues with the subsequent operations. For example, a conditional quantum operation can generate a quantum state corresponding to a position on the tree; however, the wave functions describing the quantum state subsequent to the conditional quantum operation can be immediately discarded.

On the contrary, in the greedy approach, the wave functions (i.e., wave functions 124) corresponding to each conditional unitary operation are saved by storage component 204 in a shared memory (e.g., memory 106 or another memory) accessible to one or more components comprised in dynamic quantum circuit simulation model 110. Storing wave functions 124 can impart a memory to dynamic quantum circuit simulation model 110 of the quantum states as well as the paths connecting the different quantum states along which the simulation of dynamic quantum circuit 120 has progressed. In one or more embodiments, operation execution component 212 can determine, based on classical bits resulting from application of a previous conditional unitary operation, the conditional unitary operation to be executed, and simulation component 206 can determine, based on measurement probabilities 126, the quantum states that can potentially result from application of the conditional unitary operation determined by operation execution component 212. If a quantum state has been previously generated by simulation component 206, simulation component 206 can access wave functions 124 corresponding to that quantum state from the shard memory, instead of recomputing the quantum state by applying the conditional unitary operation.

In one or more embodiments, wave functions 124 can represent a state of the quantum system of dynamic quantum circuit 120 resulting from a parallel application of multiple respective conditional unitary operations to qubits comprised in the quantum system, and simulation component 206 can execute, based on the state of the quantum system, a plurality of simulation shots in parallel. Stated differently, in one or more embodiments, the greedy approach can be parallelized, wherein operation execution component 212 can run multiple simulation shots in parallel, and wherein each simulation shot can correspond to a conditional unitary operation. Thereafter, in one or more embodiments, storage component 204 can combine and store the newly generated wave functions (i.e., wave functions 124) resulting from the parallel execution of the multiple simulation shots in a shared memory (e.g., memory 106 or another memory) accessible to one or more components comprised in dynamic quantum circuit simulation model 110. In one or more embodiments, simulation component 206 can employ the shared memory to access wave functions 124 and employ wave functions 124 in subsequent cycles of parallel simulation shots to further simulate dynamic quantum circuit 120. That is, based on wave functions 124, simulation component 206 can execute parallel simulation shots. As stated elsewhere herein, each of the parallelly executed simulation shots can correspond to respective conditional unitary operations.

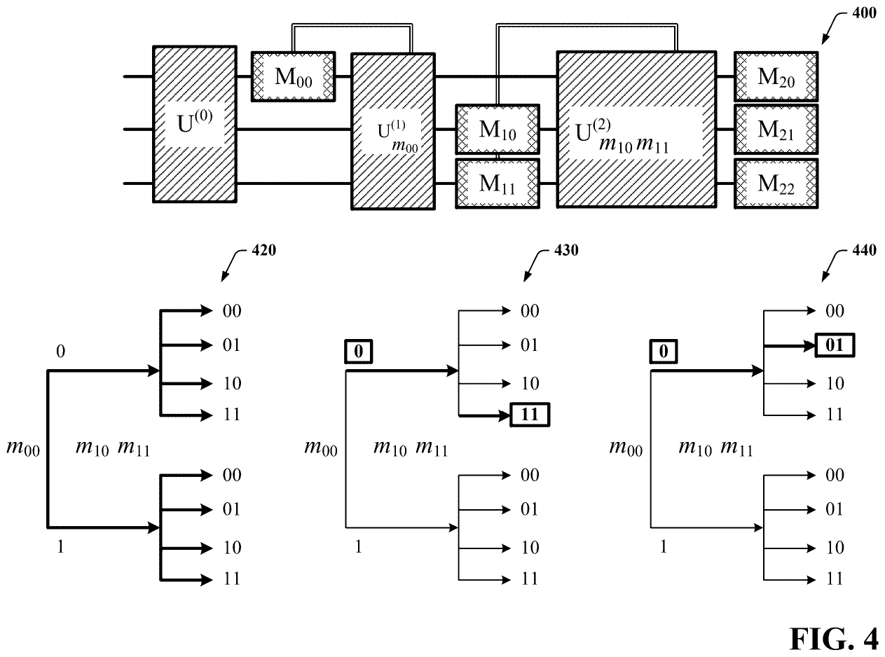

Thus, the greedy approach can be described as a checkpoint-type method, wherein wave functions describing each quantum state of dynamic quantum circuit 120 as a result of conditional unitary operations are stored in memory. Evidently, the greedy approach can reduce the number of computations involved in simulating dynamic quantum circuit 120. Employing stored wave functions to execute one or more simulation shots can, therefore, also reduce the computational time involved in simulating dynamic quantum circuit 120. Additional embodiments of the greedy approach are described with reference to FIG. 4.

### Tabular Approach:

The tabular approach can be described as a more brute force approach, wherein potential wave functions corresponding to mid-circuit measurements comprised in a dynamic quantum circuit can be generated at once. In quantum computing, a mid-circuit measurement of a qubit in a dynamic quantum circuit can introduce two possible paths along which the subsequent simulation of the dynamic quantum circuit can progress because a mid-circuit measurement can collapse a quantum state into a classical state with an outcome of either zero (0) or one (1). Thus, the total number of potential paths that can result from simulation of a dynamic quantum circuit can be equal to 2^{num_measurement}, wherein num_measurement represents the number of mid-circuit measurements.

In one or more embodiments, each of the potential paths can be simulated at once via the tabular approach. That is, instead of consecutively executing simulation shots leading to different terminals within the tree, the simulation shots can be executed at once, based on respective measurement probabilities (i.e., measurement probabilities 126) of respective mid-circuit measurements in dynamic quantum circuit 120. In various embodiments, this approach is referred to as the tabular approach. In contrast to the greedy approach, no intermediary wavefunctions need to be stored in the tabular approach.

In one or more embodiments, computation component 202 can compute respective wave functions (i.e., wave functions 124) and respective measurement probabilities (i.e., measurement probabilities 126) for respective trajectories of classical measurements corresponding to dynamic quantum circuit 120. Herein, each trajectory of classical measurement can represent a path in a tree representing potential paths along which the simulation can progress, depending on the results of different mid-circuit measurements comprised in dynamic quantum circuit 120. In one or more embodiments, computation component 202 can parallelly compute wave functions 124 and measurement probabilities 126.

In one or more embodiments, storage component 204 can store wave functions 124 and measurement probabilities 126 in a shared memory (e.g., memory 106 or another memory) accessible to one or more components comprised in dynamic quantum circuit simulation model 110. Further, in one or more embodiments, simulation component 206 can compute, based on wave functions 124 and measurement probabilities 126, a set of observables to simulate dynamic quantum circuit 120, wherein the set of observables have a defined time complexity. For example, simulation component 206 can compute the set of observables with a time complexity of 2^{2*num_qubits+num_measurements}, where in one or more embodiments, the factor of 2^{num_measurements} can be trivially parallelized. Computing the set of observables can generate expectation values. In one or more embodiments, computation component 202 can evaluate the expectation values by employing a chain rule of probabilities.

Thus, in the tabular approach, wave functions 124 and measurement probabilities 126 for dynamic quantum circuit 120 can be computed at once, based on which, subsequent computations can be performed, instead of recomputing individual wave functions separately. In scenarios where a dynamic quantum circuit comprises few mid-circuit measurements, the number of wave functions 124 computed according to the tabular approach can also be less. In some scenarios, depending on the quantum regime, simulating dynamic quantum circuit 120 can also involve a large number of simulation shots (e.g., 1,000,000 simulation shots) that can lead the simulations along any of eight paths on the tree. With the tabular approach, all eight paths can be computed at once, and subsequent computations can be performed based on the corresponding wave functions and measurement probabilities. Additional embodiments of the tabular approach are described with reference to FIG. 4.

### Deferred Measurement Approach:

As described with reference to the tabular approach, each mid-circuit measurement comprised in a dynamic quantum circuit can generate two simulation paths for the dynamic quantum circuit. In one or more embodiments, this property of mid-circuit measurements can be advantageously converted into a single simulation path by doubling the Hilbert space corresponding to the dynamic quantum circuit, via the principle of deferred measurement. For example, in one or more embodiments, compilation component 210 can compile dynamic quantum circuit 120 into a unitary quantum circuit (e.g., quantum circuit 122) comprising ancilla qubits. For example, compilation component 210 can convert each mid-circuit measurement comprised in dynamic quantum circuit 120 into a quantum operation involving an additional (ancilla) qubit, wherein the compilation can expand (i.e., double) a Hilbert space associated with dynamic quantum circuit 120. The conversion of dynamic quantum circuit 120 into quantum circuit 122 can result in a single wave function. That is, quantum circuit 122 can be described by only one wave function due to the respective mid-circuit measurements of dynamic quantum circuit 120 being converted into respective quantum operations. The wave function can be much larger than the individual wave functions (e.g., wave functions 124) resulting from the mid-circuit measurements comprised in dynamic quantum circuit 120. In one or more embodiments, the wave function can be stored by storage component 204 in a shared memory (e.g., memory 106 or another memory) accessible to one or more components comprised in dynamic quantum circuit simulation model 110 and employed for further computations. This approach is referred to as the deferred measurement approach. Thus, the deferred measurement approach can be employed when dynamic quantum circuit simulation model 110 has access to large amounts of memory to store the wave function, without utilizing large amounts of computation power.

In one or more embodiments, simulation component 206 can simulate dynamic quantum circuit 120 by executing quantum circuit 122, and dynamic quantum circuit 120 can be simulated with a defined number of elements. For example, dynamic quantum circuit 120 can be simulated with 2^{num_qubits+num_ancilla} elements. In one or more embodiments, simulation of dynamic quantum circuit 120 can generate a sparse matrix, and computation component 202 can compute, based on the sparse matrix, a set of observables with a defined time complexity. For example, the set of observables can be computed with a time complexity of 2^{2*num_qubits+num_ancilla}, wherein num_qubits+num_ancilla represents a sum of the number of qubits comprised in dynamic quantum circuit 120 (num_qubits) and the number of ancilla qubits employed to replace the mid-circuit measurements of dynamic quantum circuit 120 (num_ancilla), or with a time complexity identical to that of the tabular approach.

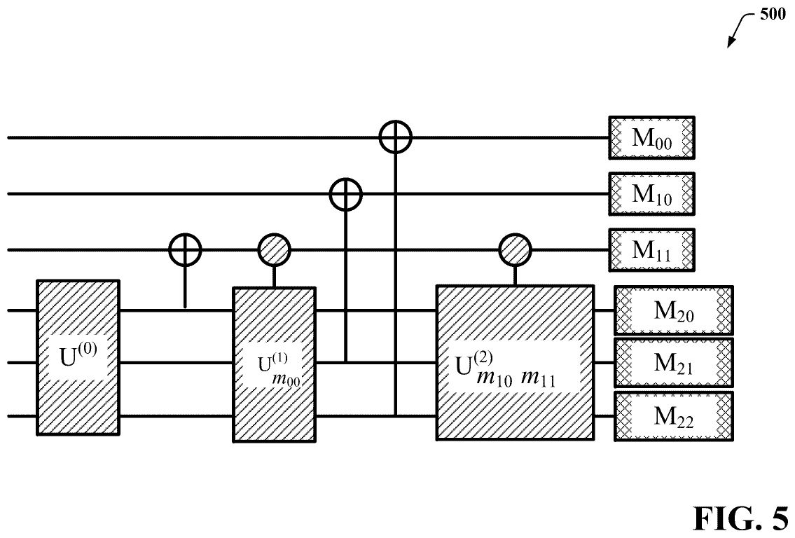

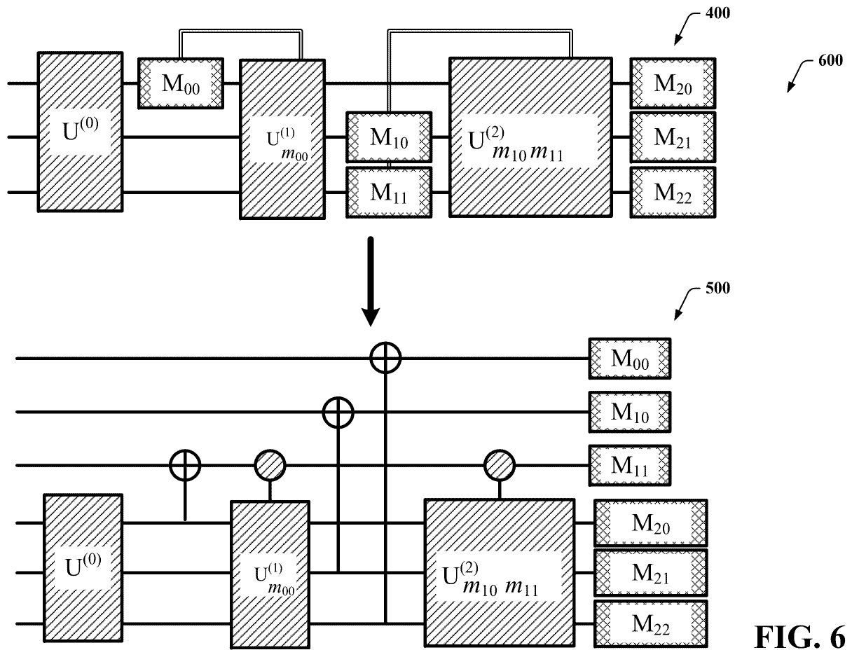

It should be appreciated that in the deferred measurement approach, although the Hilbert space, and thereby the size of the quantum system and number of qubits corresponding to dynamic quantum circuit 120 can increase with every mid-circuit measurement that is converted to a quantum operation, the increase does not result in dense matrices. For example, the matrix resulting from simulation of quantum circuit 122 can be a significantly sparse matrix, and once such sparce matrices are generated, additional operations can be efficiently performed based on such sparse matrices. The operations based on the sparse matrices can also be parallelized. For example, in mathematics, there exist certain points at which sparce matrices can be computed in parallel. In one or more embodiment, the deferred measurement approach can be straightforwardly implemented within a software stack as a transpilation pass to convert dynamic operations comprising classical logic into a unitary quantum circuit (e.g., quantum circuit 122) with a larger (but sparsely occupied) Hilbert space. Additional embodiments of the deferred measurement approach are described with reference to FIGS. 5 and 6.

In one or more embodiments, the compilation of reversible classical logic can be employed to convert dynamic circuits more efficiently into static quantum circuits. For example, when measuring the parity of a mid-circuit measurement, a single ancilla can be employed for a desirable number of measurements in the bitstring whose parity is being computed.

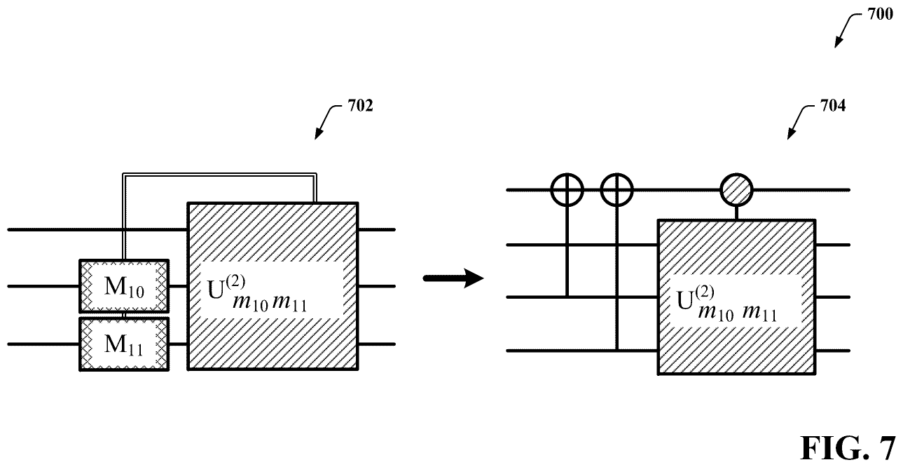

More specifically, in one or more embodiments, conditional unitary operations comprised in dynamic quantum circuit 120 can be applied on a function of measurement outcomes as opposed to raw outcomes (i.e., outcomes of mid-circuit measurements). This approach can be applicable to the greedy approach, the tabular approach and the deferred measurement approach. Recall that each mid-circuit measurement in a dynamic quantum circuit can have two possible outcomes. That is, each mid-circuit measurement can double the number of classical logical outcomes (i.e., classical bits). However, some of the classical logical outcomes can be identical to other classical logical outcomes thus generated. Stated differently, two mid-circuit measurements comprised in a dynamic quantum circuit can generate the same classical logical outcomes. Based on this fact, in one or more embodiments, the mid-circuit measurements in dynamic quantum circuit 120 can be compiled or translated and fed forward into the conditional unitary operations (i.e., qubit operations) comprised in dynamic quantum circuit 120 with a reduced number of additional (i.e., ancilla) qubits by compressing some of the ancilla qubits. For example, consider two mid-circuit measurements that can generate a total of four classical logical outcomes (i.e., 2²=4). However, a conditional unitary operation is conditioned upon the parity of measurement outcomes of preceding mid-circuit measurements, wherein the parity can refer to the number of qubits that are measured. That is, the parity of a mid-circuit measurement can indicate whether an odd number or an even number of qubits are measured as a certain quantum state. Thus, when performing mid-circuit measurements, only the parity of the mid-circuit measurements is computed. Thus, the outcomes for measurements 00 and 01 can generate the same result, and the outcomes for measurements 01 and 10 can generate the same result. This means that although two mid-circuit measurements can generate a total of four outcomes, two of the four outcomes are identical. Thus, in various embodiments, simulation component 206 can simulate dynamic quantum circuit 120 by employing only one ancilla qubit per two mid-circuit measurements to apply conditional unitary measurements to a function of measurement outcomes, and the size of the quantum system corresponding to dynamic quantum circuit 120 can double instead of quadruple. This embodiment has been additionally described with reference to FIG. 7.

FIG. 2 illustrates another block diagram of an example, non-limiting system that can efficiently simulate general dynamic quantum circuits, in accordance with one or more embodiments described herein. Repetitive description of like elements and/or processes employed in respective embodiments is omitted for sake of brevity.

FIG. 2 illustrates the system of dynamic quantum circuit simulation model 110. As discussed with reference to FIG. 1, dynamic quantum circuit simulation model 110 can comprise computation component 202, storage component 204, simulation component 206, measurement component 208, compilation component 210 and/or operation execution component 212.

In various embodiments, dynamic quantum circuit simulation model 110 can be a software for efficient and parallelizable simulation of general dynamic quantum circuits, and dynamic quantum circuit simulation model 110 can have multiple configurations. For example, in an embodiment, dynamic quantum circuit simulation model 110 can be a software or algorithm employed to simulate dynamic quantum circuit 120 via the greedy approach, and dynamic quantum circuit simulation model 110 can comprise at least storage component 204, simulation component 206, measurement component 208 and operation execution component 212.

In another embodiment, dynamic quantum circuit simulation model 110 can be a software or algorithm employed to simulate dynamic quantum circuit 120 via the tabular approach, and dynamic quantum circuit simulation model 110 can comprise at least computation component 202, storage component 204, simulation component 206 and measurement component 208.

In yet another embodiment, dynamic quantum circuit simulation model 110 can be a software or algorithm employed to simulate dynamic quantum circuit 120 via the deferred measurement approach, and dynamic quantum circuit simulation model 110 can comprise at least computation component 202, storage component 204, simulation component 206, measurement component 208 and compilation component 210.

In some embodiments, dynamic quantum circuit simulation model 110 can comprise computation component 202, storage component 204, simulation component 206, measurement component 208, compilation component 210 and operation execution component 212, and dynamic quantum circuit simulation model 110 can be employed to simulate dynamic quantum circuit 120 via the greedy approach, the tabular approach or the deferred measurement approach. In one or more embodiments, dynamic quantum circuit simulation model 110 can be employed as a software stack for applications of dynamic quantum circuits.

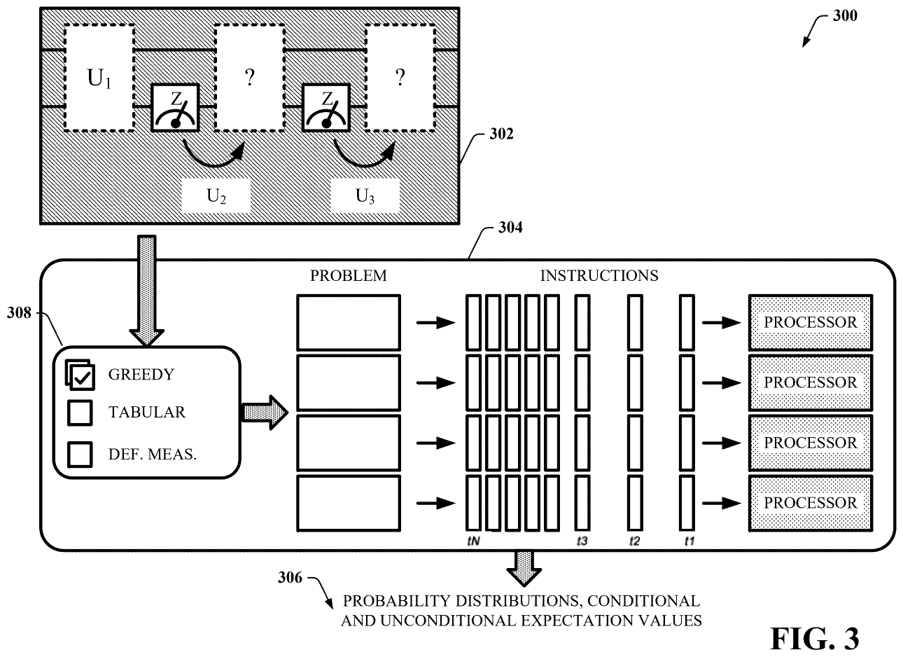

FIG. 3 illustrates a flow diagram of an example, non-limiting method 300 that can efficiently and parallelly simulate general dynamic quantum circuits, in accordance with one or more embodiments described herein. Repetitive description of like elements and/or processes employed in respective embodiments is omitted for sake of brevity.

As described elsewhere herein, a dynamic quantum circuit can generally comprise unitaries (i.e., unitary operations) followed by mid-measurements that can control/determine whether additional unitaries can follow the mid-measurements. In various embodiments, this structure of a dynamic quantum circuit can be advantageously employed to enable three different approaches (i.e., the greedy approach, the tabular approach and the deferred measurement approach) of simulating the dynamic quantum circuit, wherein each approach can be space-efficient, time-efficient and parallelizable.

With continued reference to FIGS. 1 and 2, non-limiting method 300 illustrates additional embodiments of dynamic quantum circuit simulation model 110. At 302, non-limiting method 300 illustrates a general dynamic quantum circuit (e.g., dynamic quantum circuit 120), wherein U₁, U₂ and U₃ represent conditional unitary operations separated by mid-circuit measurements, such that the outcome of the first mid-circuit measurement can determine the quantum operations comprised in U₂, and the outcome of the second mid-circuit measurement can determine the quantum operations comprised in U₃. In one or more embodiments, dynamic quantum circuit simulation model 110 can access dynamic quantum circuit 120. As illustrated at 304, dynamic quantum circuit simulation model 110 can employ the greedy approach, the tabular approach or the deferred measurement approach (block 308) to generate a space-efficient representation of dynamic quantum circuit 120. In one or more embodiments, dynamic quantum circuit simulation model 110 can employ the space-efficient representation to simulate dynamic quantum circuit 120 via a time-efficient parallelization by parallelly executing quantum operations on a quantum processor. As illustrated at 306, the outcomes generated by simulating dynamic quantum circuit 120 can be employed to perform additional computations such as computations of probability distributions, conditional and unconditional expectation values, etc.

FIG. 4 illustrates diagrams of an example, non-limiting dynamic quantum circuit 400 and example, non-limiting simulation shots 430 and 440 to describe a greedy approach and a tabular approach of simulating a dynamic quantum circuit, in accordance with one or more embodiments described herein. Repetitive description of like elements and/or processes employed in respective embodiments is omitted for sake of brevity.

FIG. 4 illustrates a general setup of a dynamic quantum circuit. In one or more embodiments, non-limiting dynamic quantum circuit 400 can be an example of dynamic quantum circuit 120, wherein M_{dj} represents a measurement at layer d on qubit j, m_{dj} represents an outcome of the measurement at layer d on qubit j(0,1), and

$${U}_{{m}_{{d}_{0} {j}_{0}} {m}_{{d}_{1} {j}_{1}} …}^{{( d )}_{0}}$$

represents a unitary operation on layer d conditioned on the measurement of qubit j₀ on layer d₀ and on the measurement of qubit j₁ on layer d₁, and so on.

As illustrated, non-limiting dynamic quantum circuit 400 can comprise a family of quantum circuits (e.g., conditional unitary operations) that can be executed probabilistically based on the outcomes of the mid-circuit measurements comprised in non-limiting dynamic quantum circuit 400. For example, non-limiting dynamic quantum circuit 400 can comprise unitary quantum circuit

$${U}_{{m}_{10} {m}_{11}}^{( 2 )} {U}_{{m}_{00}}^{( 1 )} {U}_{0}^{( 0 )}$$

that can be executed with a measurement probability P(m₀₀)P(m₁₀m₁₁|m₀₀). According to existing approaches of simulating dynamic quantum circuits, non-limiting dynamic quantum circuit 400 can be simulated sequentially by first sampling m₀₀, followed by applying

$${U}_{{m}_{00}}^{( 1 )} ,$$

followed further by sampling m₁₀, m₁₁ and finally applying

$${U}_{{m}_{10} {m}_{11}}^{( 2 )} ,$$

during each simulation snot. Such simulations are typically costly, and the costly simulations are repeated during each simulation shot.

As stated elsewhere herein, embodiments of the present disclosure aim to reduce the number of costly simulations involved in simulating dynamic quantum circuits. For example, the greedy approach of simulating non-limiting dynamic quantum circuit 400 can begin in a manner similar to existing approaches. However, at each step, storage component 204 can save or store wave functions (e.g., wave functions 124) resulting from the application of the conditional unitary operations and the measurement probabilities (e.g., measurement probabilities 126) corresponding to the wave functions in a memory (e.g., memory 106 or another memory). The stored wave functions can be employed for subsequent simulation of non-limiting dynamic quantum circuit 400, as described with reference to FIG. 1. As a result, repeated simulation paths do not need to be simulated twice.

In FIG. 4, tree 420 represents potential paths along which the simulation of non-limiting dynamic quantum circuit 400 can progress subsequent to measurements M₀₀, M₁₀ and M₁₁. In one or more embodiments, storage component 204 can store the wave functions

$${U}^{( 0 )} \vert {ψ}_{0} 〉 , {U}_{{m}_{00} = 0}^{( 1 )} {U}^{( 0 )} \vert {ψ}_{0} 〉 and {U}_{{m}_{01} {m}_{11} = 11}^{( 1 )} {U}_{{m}_{00} = 0}^{( 1 )} {U}^{( 0 )} \vert {ψ}_{0} 〉$$

resulting from non-limiting simulation shot 430 (e.g., shot 1). As the simulation progresses, simulation component 206 can access and reuse the stored wave functions U⁽⁰⁾|ψ₀ [symbol] and Uₘ_{₀₀}=0⁽¹⁾U⁽⁰⁾|ψ₀ [symbol] during non-limiting simulation shot 440, leaving only the wave function Uₘ_{₀₁}ₘ_{₁₁}₌₀₁⁽¹⁾ Uₘ_{₀₀}₌₀⁽¹⁾U⁽⁰⁾|ψ₀ [symbol] to be generated by operation execution component 212 by applying the relevant conditional unitary operations to one or more qubits comprised in dynamic quantum circuit 120.

Existing approaches of simulating dynamic quantum circuits and the greedy approach can be prone to statistical errors because these approaches involve sampling outcomes to estimate expectation values of observables. In various embodiments, the tabular approach can be employed to generate exact expectation values for observables by enumerating and storing all potential paths or cases along which the simulation of a dynamic quantum circuit can progress. For example, with specific reference to non-limiting dynamic quantum circuit 400, in one or more embodiments, computation component 202 can calculate final wave functions (e.g., wave functions 124) for all paths, that is, all configurations of m₀₀ and m₁₀m₁₁, and storage component 204 can store the wave functions in memory (e.g., memory 106 or another memory). In one or more embodiments, computation component 202 can further evaluate exact expectations values of observables by employing the chain rule of probabilities and the stored wave functions. For example, computation component 202 can compute the expectation value of interest xₘ_{₀₀}_{;m}_{₁₀}ₘ_{₁₁} by calculating the summation ΣP(m₀₀)P(m₁₀m₁₁|m₀₀)xₘ_{₀₀}_{;m}_{₁₀}ₘ_{₁₁} based on the wave function corresponding to the m₀₀m₁₀m₁₁ path (i.e., branch of tree 420).

FIG. 5 illustrates a diagram of an example, non-limiting quantum circuit 500 to describe a deferred measurement approach of simulating a dynamic quantum circuit, in accordance with one or more embodiments described herein. With continued reference to FIG. 5, FIG. 6 illustrates a flow diagram of an example, non-limiting method 600 to describe the deferred measurement approach of simulating a dynamic quantum circuit, in accordance with one or more embodiments described herein. Repetitive description of like elements and/or processes employed in respective embodiments is omitted for sake of brevity.

As described with reference to FIG. 1, the deferred measurement approach of simulating dynamic quantum circuits can comprise generating a single wave function in an expanded Hilbert space by compiling a dynamic quantum circuit into a new, unitary quantum circuit. For example, by employing the principle of deferred measurement, compilation component 210 can compile dynamic quantum circuit 120 into quantum circuit 122 with ancillas (i.e., ancilla qubits). Quantum circuit 122 can be unitary quantum circuit comprising only quantum operations. Additionally, quantum circuit can be a static quantum circuit as opposed to a dynamic quantum circuit. In one or more embodiments, quantum circuit 122 can comprise the same measurement statistics as dynamic quantum circuit 120; however, quantum circuit 122 can be employed to calculate exact expectation values of observables or to sample outcomes by simulating quantum circuit 122 only once and employing the wave function computed as a result of the simulation for subsequent computations. Although the additional (i.e., ancilla) qubits introduced into dynamic quantum circuit 120 to compile quantum circuit 122 can increase the cost of the simulation, the sparse structure of operations involved between the system qubits (i.e., qubits originally comprised in dynamic quantum circuit 120) and the ancilla qubits can ensure that the complexity of the simulation does not grow by an amount similar to dense circuits of the same size as dynamic quantum circuit 120. The number of ancilla qubits in quantum circuit 122 can be, at most, equal to the number of mid-circuit measurements in dynamic quantum circuit 120.

Non-limiting quantum circuit 500 illustrates an example of quantum circuit 122. In one or more embodiments, non-limiting quantum circuit 500 can be generated from non-limiting dynamic quantum circuit 400 via the deferred measurement approach, as further illustrated by non-limiting method 600 of FIG. 6. For example, compilation component 210 can replace mid-circuit measurements in non-limiting dynamic quantum circuit 400 with controlled-X(CX) gates from the qubit being measured by a mid-circuit measurements to an ancilla qubit introduced by compilation component 210. A CX gate is a quantum gate that can operate on two qubits—a control qubit and a target qubit. As a result, feed forward operations, that is, conditional unitary operations comprised in non-limiting dynamic quantum circuit 400 can be converted to conditional quantum gates on the ancilla qubit, and non-limiting dynamic quantum circuit 400 can be compiled into non-limiting quantum circuit 500.

FIG. 7 illustrates a flow diagram of an example, non-limiting method 700 to show the computation of parity in the deferred measurement approach of simulating a dynamic quantum circuit, in accordance with one or more embodiments described herein. Repetitive description of like elements and/or processes employed in respective embodiments is omitted for sake of brevity.

With continued reference to at least FIGS. 1 and 4, non-limiting method 700 further describes embodiments of the present disclosure where conditional unitary operations comprised in dynamic quantum circuits can be conditioned upon functions of measurement outcomes as opposed to raw outcomes. For example, if a conditional unitary operation is conditioned on the parity of measurement outcomes, simulation component 206 can employ a single ancilla to simulate the conditional unitary operation. For example, in non-limiting method 700, the conditional unitary operation

$${U}_{{m}_{10} {m}_{11}}^{( 2 )}$$

at 702 can be conditional upon the parities of m₁₀ and m₁₁, and computation component 202 can convert the conditional unitary operation into the quantum operation with ancilla qubits at 704. Thereafter, simulation component 206 can simulate the conditional unitary operation at 702 by executing (e.g., on quantum computing system 112) the quantum operation at 704. Each of the greedy approach, the tabular approach and the deferred measurement approach can be adapted to incorporate these embodiments.

For example, in the greedy and the tabular approach, conditional unitary operations can be conditioned upon functions of measurement outcomes by evaluating (e.g., by computation component 202) the probability of an output of a function, given measurement inputs. This can be achieved by employing outcome probabilities and the definition of a function.

In the deferred measurement approach, the function can be synthesized by employing (e.g., by computation component 202) classical logical function synthesis and directly applying (e.g., by simulation component 206) the function in the dynamic quantum circuit to be simulated. Further optimization can be achieved by reducing the number of ancillas from the number of mid-circuit measurements to a number equal to log (number of function outputs).

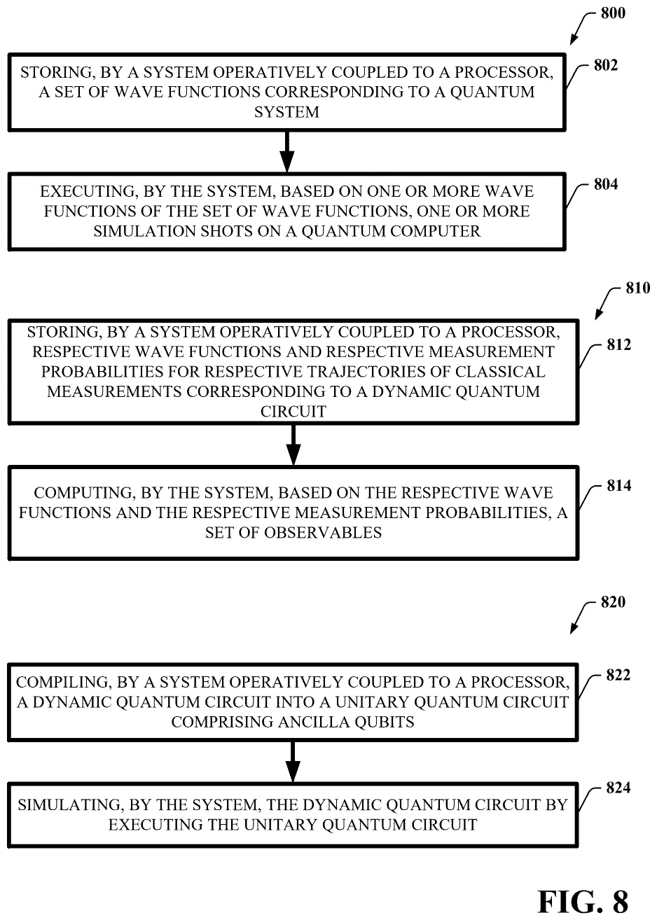

FIG. 8 illustrates flow diagrams of example, non-limiting methods 800, 810 and 820 that can efficiently simulate general dynamic quantum circuits, in accordance with one or more embodiments described herein. Repetitive description of like elements and/or processes employed in respective embodiments is omitted for sake of brevity.

Non-limiting method 800 corresponds to the greed approach of simulating dynamic quantum circuits.

At 802, non-limiting method 800 can comprise storing (e.g., by storage component 204), by a system operatively coupled to a processor, a set of wave functions corresponding to a quantum system.

At 804, non-limiting method 800 can comprise executing (e.g., by simulation component 206), by the system, based on one or more wave functions of the set of wave functions, one or more simulation shots on a quantum computer.

Non-limiting method 810 corresponds to the tabular approach of simulating dynamic quantum circuits.

At 812, non-limiting method 810 can comprise storing (e.g., by storage component 204), by a system operatively coupled to a processor, respective wave functions and respective measurement probabilities for respective trajectories of classical measurements corresponding to a dynamic quantum circuit.

At 814, non-limiting method 810 can comprise computing (e.g., by simulation component 206), by the system, based on the respective wave functions and the respective measurement probabilities, a set of observables.

Non-limiting method 820 corresponds to the deferred measurement approach of simulating dynamic quantum circuits.

At 822, non-limiting method 820 can comprise compiling (e.g., by compilation component 210), by a system operatively coupled to a processor, a dynamic quantum circuit into a unitary quantum circuit comprising ancilla qubits.

At 824, non-limiting method 820 can comprise simulating (e.g., by simulation component 206), by the system, the dynamic quantum circuit by executing the unitary quantum circuit.

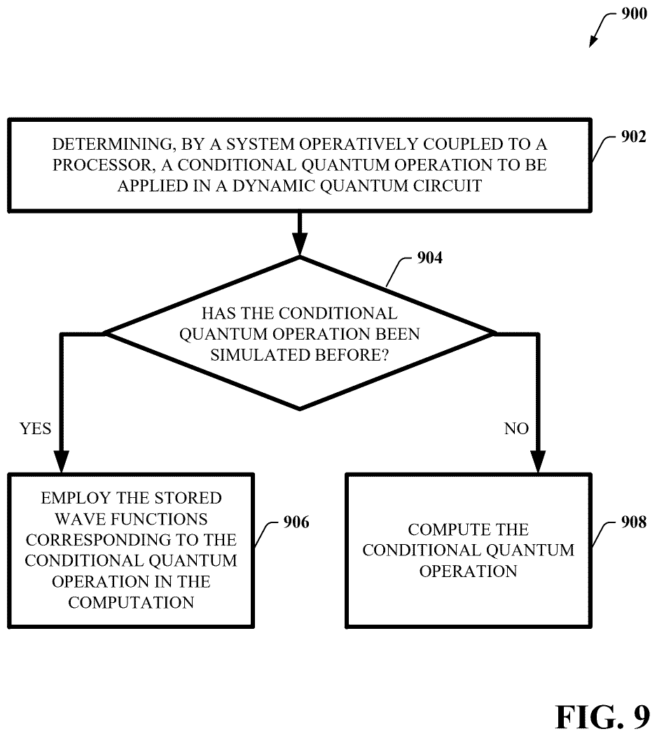

FIG. 9 illustrates another flow diagram of an example, non-limiting method 900 that can efficiently simulate general dynamic quantum circuits, in accordance with one or more embodiments described herein. Repetitive description of like elements and/or processes employed in respective embodiments is omitted for sake of brevity.

Non-limiting method 900 describes additional embodiments of the greedy approach.

At 902, non-limiting method 900 can comprise determining (e.g., by operation execution component 212), by a system operatively coupled to a processor, a conditional quantum operation to be applied in a dynamic quantum circuit.

At 904, non-limiting method 900 can comprise determining (e.g., by simulation component 206), by the system, whether the conditional quantum operation has been simulated before.

If yes, then at 906, non-limiting method 900 can comprise employing (e.g., by simulation component 206), by the system, the stored wave functions corresponding to the conditional quantum operation in the computation.

If not, then at 908, non-limiting method 900 can comprise computing (e.g., by simulation component 206), by the system, the conditional quantum operation, that is, computing the entire conditional quantum operation as opposed to computing only a portion of the conditional quantum operation due to the unavailability of stored wave functions.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ AI to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

FIG. 10 illustrates a block diagram of an example, non-limiting, operating environment 1000 in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as dynamic quantum circuit simulation code 1028. In addition to block 1028, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1028, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer-readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1028 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in block 1028 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer-readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

CLOUD COMPUTING SERVICES AND/OR MICROSERVICES (not separately shown in FIG. 10): private and public clouds 1006 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a storage component that stores a set of wave functions corresponding to a quantum system; and
a simulation component that executes, based on one or more wave functions of the set of wave functions, one or more simulation shots on a quantum computer.

2. The system of claim 1, wherein the set of wave functions represents a state of the quantum system resulting from application of a conditional unitary operation to qubits comprised in the quantum system, and wherein the system further comprises:
an operation execution component that applies the conditional unitary operation to the qubits, wherein the conditional unitary operation is based on classical bits that result from measurement of one or more qubits comprised in the quantum system, and wherein the conditional unitary operation is applied as a simulation shot.

3. The system of claim 2, further comprising:
a measurement component that measures the one or more qubits subsequent to application of a set of unitary operations to the one or more qubits.

4. The system of claim 3, wherein the operation execution component further applies the set of unitary operations to the one or more qubits.

5. The system of claim 1, wherein the set of wave functions represents a state of the quantum system resulting from a parallel application of multiple respective conditional unitary operations to qubits comprised in the quantum system, and wherein the simulation component executes, based on the state of the quantum system, a plurality of simulation shots in parallel.

6. The system of claim 2, wherein the simulation shot and the one or more simulation shots are executed to simulate a dynamic quantum circuit.

7. The system of claim 6, wherein employing stored wave functions to execute the one or more simulation shots reduces a computational time involved in simulating the dynamic quantum circuit.

8. A computer-implemented method, comprising:
storing, by a system operatively coupled to a processor, a set of wave functions corresponding to a quantum system; and
executing, by the system, based on one or more wave functions of the set of wave functions, one or more simulation shots on a quantum computer.

9. The computer-implemented method of claim 8, wherein the set of wave functions represents a state of the quantum system resulting from application of a conditional unitary operation to qubits comprised in the quantum system, and wherein the computer-implemented method further comprises:
applying, by the system, the conditional unitary operation to the qubits, wherein the conditional unitary operation is based on classical bits that result from measurement of one or more qubits comprised in the quantum system, and wherein the conditional unitary operation is applied as a simulation shot.

10. The computer-implemented method of claim 9, further comprising:
measuring, by the system, the one or more qubits subsequent to application of a set of unitary operations to the one or more qubits.

11. The computer-implemented method of claim 10, further comprises:
applying, by the system, the set of unitary operations to the one or more qubits.

12. The computer-implemented method of claim 8, wherein the set of wave functions represents a state of the quantum system resulting from a parallel application of multiple respective conditional unitary operations to qubits comprised in the quantum system, and wherein the computer-implemented method further comprises:
executing, by the system, based on the state of the quantum system, a plurality of simulation shots in parallel.

13. A computer program product to simulate general dynamic quantum circuits, the computer program product comprising a computer readable storage medium having program instructions embodied therewith, the program instructions executable by a processor to cause the processor to:
store, by the processor, a set of wave functions corresponding to a quantum system; and execute, by the processor, based on one or more wave functions of the set of wave functions, one or more simulation shots on a quantum computer.

14. The computer program product of claim 13, wherein the set of wave functions represents a state of the quantum system resulting from application of a conditional unitary operation to qubits comprised in the quantum system, and wherein the program instructions are further executable by the processor to cause the processor to:
apply, by the processor, the conditional unitary operation to the qubits, wherein the conditional unitary operation is based on classical bits that result from measurement of one or more qubits comprised in the quantum system, and wherein the conditional unitary operation is applied as a simulation shot.

15. The computer program product of claim 14, wherein the program instructions are further executable by the processor to cause the processor to:
measure, by the processor, the one or more qubits subsequent to application of a set of unitary operations to the one or more qubits.

16. The computer program product of claim 15, wherein the program instructions are further executable by the processor to cause the processor to:
apply, by the processor, the set of unitary operations to the one or more qubits.

17. The computer program product of claim 13, wherein the set of wave functions represents a state of the quantum system resulting from a parallel application of multiple respective conditional unitary operations to qubits comprised in the quantum system, and wherein the program instructions are further executable by the processor to cause the processor to:
execute, by the processor, based on the state of the quantum system, a plurality of simulation shots in parallel.

18. A system, comprising:
a memory that stores computer executable components; and
a processor that executes the computer executable components stored in the memory, wherein the computer executable components comprise:
a storage component that stores respective wave functions and respective measurement probabilities for respective trajectories of classical measurements corresponding to a dynamic quantum circuit; and
a simulation component that computes, based on the respective wave functions and the respective measurement probabilities, a set of observables.

19. The system of claim 18, further comprising:
a computation component that computes the respective wave functions and the respective measurement probabilities for the respective trajectories of classical measurements, wherein the respective wave functions and the respective measurement probabilities are computed parallelly.

20. The system of claim 18, wherein the set of observables have a defined time complexity, and wherein the set of observables are computed to simulate the dynamic quantum circuit.

21. A system, comprising:
a memory that stores computer executable components; and
a processor that executes the computer executable components stored in the memory, wherein the computer executable components comprise:
a compilation component that compiles a dynamic quantum circuit into a unitary quantum circuit comprising ancilla qubits; and
a simulation component that simulates the dynamic quantum circuit by executing the unitary quantum circuit.

22. The system of claim 21, wherein simulation of the dynamic quantum circuit generates a sparse matrix, and wherein the system further comprises:
a computation component that computes, based on the sparse matrix, a set of observables with a defined time complexity.

23. The system of claim 21, wherein the dynamic quantum circuit is simulated with a defined number of elements.

24. The system of claim 21, wherein compiling the dynamic quantum circuit into the unitary quantum circuit expands a Hilbert space associated with the dynamic quantum circuit.

25. The system of claim 21, wherein the unitary quantum circuit is associated with a single wave function.
